(19) United States
(12) Patent Application Publication
(10) Pub. No.: US 2022/0218007 A1
(43) Pub. Date: Jul. 14, 2022

(54) METHODS AND COMPOSITION TO REDUCE SALT IN FOOD PRODUCTS

(71) Applicants: Raghavi Kantharuban, Fremont, CA (US); Chockkalingam Karuppaiah, Fremont, CA (US)

(72) Inventors: Raghavi Kantharuban, Fremont, CA (US); Chockkalingam Karuppaiah, Fremont, CA (US)

(21) Appl. No.: 17/575,168

(22) Filed: Jan. 13, 2022

Related U.S. Application Data
(60) Provisional application No. 63/137,296, filed on Jan. 14, 2021.

(51) Int. Cl. A23L 27/00; A23L 27/40; A23L 19/12

(52) U.S. Cl. CPC A23L 27/79; A23L 19/12; A23L 27/40

(57) ABSTRACT

In one embodiment, a method for a food product is disclosed. The method includes moving a food product over a conveyer belt, spraying a salt solution onto outside surfaces of the food product, drying the salt solution onto the outside surfaces of the food product, and packaging the food product for shipment.

### CROSS-REFERENCE TO RELATED APPLICATIONS

This non-provisional United States (U.S.) patent application claims the benefit of U.S. Provisional Patent Application No. 63/137,296 titled METHODS AND COMPOSITION TO REDUCE THE AMOUNT OF SALT UTILIZED IN FOOD PRODUCTS filed on Jan. 14, 2021, by inventors Raghavi Kantharuban and Chockkalingam Karuppaiah.

### FIELD

The disclosed embodiments generally relate to sodium chloride salt coatings for vegetable food products.

### BACKGROUND

Vegetable meat-like food products (synthetic protein food products, meat analogs, or synthetic meats), such as a vegetable burger (vegie-burger), have been introduced to reduce fat and provide an alternative meat like food product for vegetarians to eat. For example, U.S. Pat. No. 4,001,441 titled MEAT ANALOG issued to Alexander Liepa on Jan. 4, 1977, incorporated by reference for all intents and purposes, describes various processes of making meat analogs that closely resemble meat in appearance, texture, and eating quality. U.S. Pat. No. 5,571,545 titled HAMBURGER TYPE FOOD MATERIAL AND PROCESS OF MAKING IT issued to Yokoyama et al. on Nov. 5, 1996, incorporated by reference for all intents and purposes, describes using granular soybean proteins as a main ingredient. U.S. Pat. No. 7,070,827 titled VEGETABLE PROTEIN MEAT ANALOG issued to Cavallini et al. on Jul. 4, 2006, incorporated by reference for all intents and purposes, generally describes using a plant protein such as from soybeans, corn, or dry beans with at least one flavoring ingredient to provide an improved taste. One of the flavoring ingredients may be sodium chloride (NaCl) salt.

Vegetable burgers with improved taste and eating qualities have started to become popular at restaurants. However, the sodium chloride (NaCl) salt content can be relatively high, thereby increasing blood pressure that can lead to hypertension or other health risks in humans eating such improved vegetable burgers. Dietary Guidelines for Americans recommends to keep daily sodium intake from salt to less than 2,300 mg a day. The American Heart Association recommends 1,500 mg a day of sodium from salt as an upper limit for all adults.

With roughly half of the adult population of the United States (U.S.) having high blood pressure, more and more people are looking to reduce their high sodium intake, which is one of the leading causes of it. According to the Center for Disease Control (CDC), hypertension plagues forty-five percent of the adult population in the U.S., and about only twenty-four percent of them have it under control. Many don't want to sacrifice eating sodium filled food to manage their conditions, leading to people searching for different solutions.

Lifestyles can also get in the way of being as healthy as possible. If a vegetarian person were to eat a vegetarian burger (e.g., an IMPOSSIBLE burger) as opposed to a meat (ground beef) burger, they would likely consume almost triple the amount of sodium due to extra salt being added to improve the taste of the vegetarian burger. This person would avoid a whole type of food (burgers) to reduce their risk of getting hypertension, a heart attack, or a stroke. Adding less salt into a vegetarian burger can make its taste much less authentic and meat-like, such that it discourages many from reducing the salt content in the vegetarian burger.

In the end, the issue is trying to reduce or eliminate the sodium in food, without affecting taste. Some solutions to reduce salt content have been tried, but none have stuck due to many reasons.

One solution was to use Himalayan salt instead of table salt that is normally used in food products. At first, Himalayan salt sounds much better since it has been proven to have more minerals in it, but after further research, it can be shown that the difference between Himalayan salt and table salt is minimal. Himalayan salt is chemically similar to table salt. Analysis of a range of Khewra salt samples showed them to be between ninety-six percent (96%) and ninety-nine (99%) sodium chloride, with varying amounts of trace minerals such as calcium, iron, zinc, chromium, magnesium and sulfate, all at safe levels below one percent (1%). Nutritionally, Himalayan salt is similar to common table salt, though it lacks the beneficial iodine that is added to commercial iodized table salt. Iodized table salt is table salt mixed with a minute amount of various salts of the element iodine.

Another attempted solution was to substitute sodium with lithium, but it cannot be used with a food product that is consumed, due to lithium being poisonous to humans.

It is desirable to reduce the salt content in food products in order to lower blood pressure and reduce health risks in humans while substantially retaining or improving its tastiness.

### BRIEF SUMMARY

The disclosed embodiments are summarized by the claims that follow below.

### BRIEF DESCRIPTIONS OF THE DRAWINGS

Disclosed embodiments are exemplified in the figures that are briefly discussed as follows.

FIG. 1A is a side view of a vegetarian burger patty with a salt coating.

FIG. 1B is a top view of a circular shaped vegetarian burger patty with the salt coating.

FIG. 1C is a top view of a rectangular shaped vegetarian burger patty with the salt coating.

FIG. 2 is a chart illustrating the quantity of salt in each slice of a salt coated vegetarian burger patty, such as shown in FIG. 1.

FIG. 3 is a diagram of a perspective view that illustrates the application of the disclosed salt composition to an outer surface of a food product in a food production line.

FIG. 4 is a side view of vegetarian hamburger assembled together with the salt coated vegetarian burger patty having an outer surface coated with salt.

### DETAILED DESCRIPTION

In the following detailed description of the embodiments of the invention, numerous specific details are set forth in order to provide a thorough understanding of the present invention. However, it will be obvious to one skilled in the art that the embodiments of the invention may be practiced without these specific details. In other instances, well known methods, procedures, components, and circuits have not been described in detail so as not to unnecessarily obscure aspects of the embodiments of the invention.

The embodiments include methods of utilizing salt, water, and various spices to create tastier food products with less salt. Different types of salts can be used food products, such as sea salt, iodized and non-iodized table salt, Kosher salt, Himalayan salt, and pink salt. The different types of salts can also have different grain sizes or diameters described as rock (8 mm-12 mm), coarse (2 mm-8 mm), kosher (1 mm-2 mm), fine (less than 1 mm to 0.2 mm), or powder (superfine-less than 0.2 mm) in grain size from large to small respectively.

In one embodiment, salt is dissolved into water to create a salt solution. The salt solution is then sprayed onto the surface of a food product, such as a burger. By diluting the salt in the water of the salt solution, the concentration of salt utilized in a recipe can be controlled to a higher degree. The amount of salt dissolved and thus the concentration of the salt solution can be minutely controlled. Furthermore, a spray pattern of spray heads can be controlled to deliver a fine mist of salt solution, evenly coating the entire surface area of the food product. The salt solution can be used to selectively coat the surface of the food.

As the water in the sprayed salt solution evaporates, deposits of tiny salt particles are left on the outside surfaces of the food product. This method is most practical on foods that can go through a warming process. As the water in the solution evaporates away due to the applied heat, it leaves behind a fine layer of salt particles. The salt particles, left after the evaporation of the salt water solution, are smaller in size (e.g., diameter) than found in geologically occurring salt, such as found in salt mines or rock salt. The salt particles utilized by the disclosed embodiments are also smaller in size than many commercially available food grade salts (e.g., 2 mm to 1 mm diameter). During the manufacturing process of the food product, the salt solution gets dried, leading to the formation of small salt particles on the outside surface of the food product.

Smaller salt particles make the salt more potent because of a high surface area to volume ratio. The salt can taste saltier because the greater surface area of the smaller particles of salt causes the salt particles to dissolve much faster when dissolved on the tongue and its taste buds. The more surface area to volume, the saltier the particle feels to the taste buds. This burst of salt flavor from the rapidly dissolving tiny salt particles trick the taste buds into thinking there is more salt than there really is.

Concentrating the salt crystals on the outside of the food product, as opposed to evenly distributing it throughout the food product, further magnifies the salt flavor burst from the tiny salt crystals. Taste buds and taste receptors found on the upper surface of a diner's tongue encounters the thin layer of salt first when biting into the food product. The taste buds are again fooled into thinking there is a large amount of salt present when in reality there is only a thin layer of salt deposits. The solution of salt and water can be sprayed as an even coat onto the surface of food to achieve a consistent, salty taste with very little salt actually used.

To reduce the amount of salt inside the food product, various spices including, but not limited to, onion powder, garlic powder, chili powder, ginger, turmeric, paprika, lemon juice extract, sugar, and/or black pepper can be added. Adding different flavors, especially spicy ones, reduces a person's craving for salt. For example, adding one or more of onion powder, garlic powder, chili powder, turmeric, ginger, lemon juice extract, sugar, and/or black pepper into a veggie burger (vegetable hamburger) makes it tastier, thereby reducing the reliance on salt for flavor.

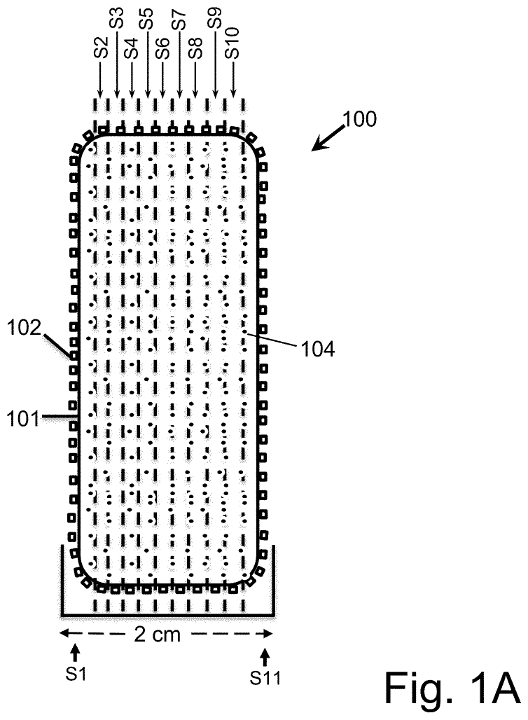

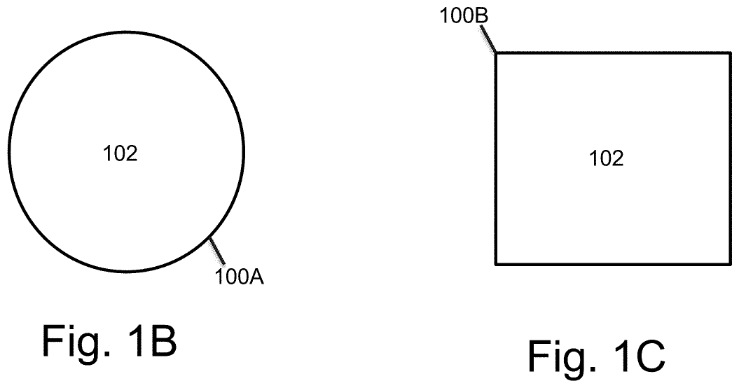

FIG. 1A illustrates a side cross section view (side profile) of an exemplary salt coated vegetarian burger patty 100. An outer surface 101 (top surface, bottom surface, and edge or side surfaces) of the salt coated vegetarian burger patty 100 is coated with salt 102 (salt coating 102). One or more spices 104, other than salt, can be inserted and formed as part of the vegetarian burger patty 100 prior to being coated with salt. The one or more spices can be, but not limited to, onion powder, garlic powder, chili powder, ginger, turmeric, paprika, lemon juice extract, sugar, and/or black pepper.

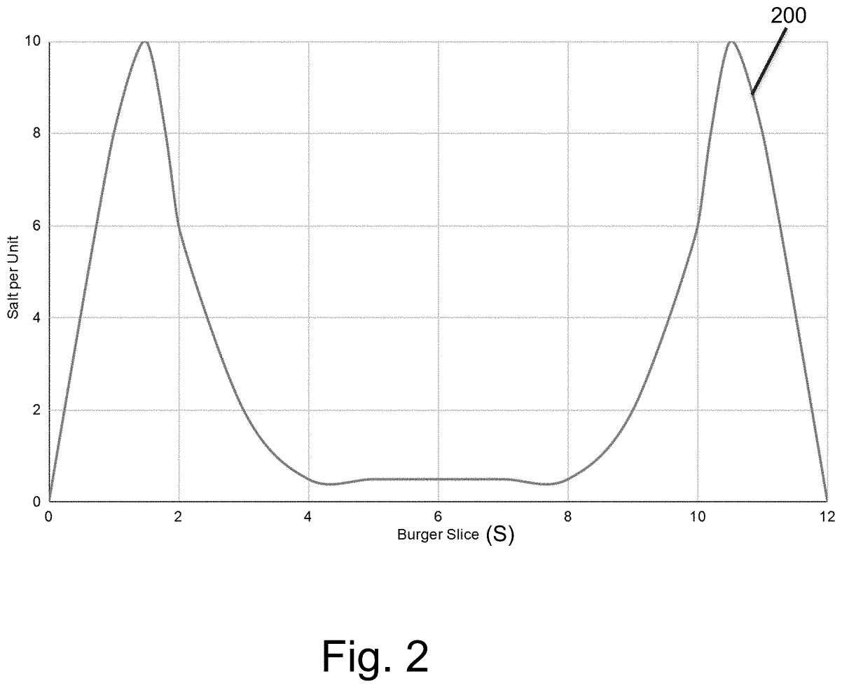

The salt coated vegetarian burger patty 100 has a thickness and can be divided into a plurality of slices of substantially equal volume to measure salt concentrations of the patty. For example, the salt coated vegetarian burger patty 100 can be two centimeters (cm) thick and divided into eleven slices, slices S1 through S11. The salt concentrations of each slice of the salt coated vegetarian burger patty 100 can be measured and plotted, such as shown in FIG. 2.

The salt coated vegetarian burger patty 100 can be formed into different shapes. FIG. 1B is a top view of a circular shaped salt coated vegetarian burger patty 100A with the salt coating 102. FIG. 1C is a top view of a rectangular shaped salt coated vegetarian burger patty 100B with the salt coating 102.

FIG. 2 shows a chart of a diffusion of salt across the side profile of a salt coated vegetarian burger, such as the salt coated vegetarian burger 100 shown in FIG. 1A. Along the X-axis, FIG. 2 shows slices S1 through S11, eleven slices of a salt coated vegetarian burger. There is no slice S0 or slice S12. Along the Y-axis, FIG. 2 shows a concentration of salt per volume. The plotted curve 200 shows the salt concentration per volume for each slice of the salt coated vegetarian burger. With no slice S0 and no slice S12, the salt concentration is zero at the end points of the plotted curve 200.

With the salt coated vegetarian burger, the plotted curve 200 shows that the salt solution is strongest in the top slice S1 (including the top outer surface) and the bottom slice S11 (including the bottom outer surface). There is little to no salt in the interior of the salt coated vegetarian burger. However, small amounts of salt leak over from the outer surfaces of the top slice S1 and the bottom slice S11 onto the outer side surfaces of the vegetarian burger. When the top and bottom surfaces are sprayed with a salt solution, there is likely to be some overspray of salt onto side surfaces as well. Accordingly, the inner slices S2 through S10 show some small amounts of salt concentration from that which leaks onto and is over-sprayed onto the outer side surface(s). In summary, there is more salt per volume in the outer slices, the top slice S1 and the bottom slice S11, of the salt coated vegetarian burger. The maximum magnitude of salt per volume in the outer slices S1,S11 is still less than the salt diffused throughout and into the inside of typical prior art vegetable patties.

In a typical bite of the vegetarian burger patty 100, a person's tongue first encounters the outer surface of the patty. The outer surface of the patty contains the highest concentration of salt to veggie burger volume. This thin layer of concentrated tiny salt deposits dissolves quickly when encountered by a person's tongue. The taste buds on the tongue signals the person's brain that the veggie burger is sufficiently salty and tasty, even though the inside of the burger has almost no salt. The thin layer of salt deposit on the outer surface of the food product is what the taste receptors taste first, tricking the mind into thinking there is much more salt than there really is. With the outer surface being salted by the salt solution, salt can be reduced from inside the burger as compared to a typical burger patty.

The distribution of salt is altered to have higher surface concentration in comparison to what is inside the burger to enable overall reduction of salt quantity without impacting the taste reception. This is enabled by fine particles of salt deposited on the outside surface coming in contact with the tongue first. In contrast, a typical vegetable burger has the salt distributed evenly throughout the volume of the burger. If sliced as shown in FIG. 1A, a typical vegetable burger would have an equal amount of salt in each of the slices of slice S1 through slice S10.

An exemplary method of processing the food product according to the disclosed embodiments is disclosed. The disclosed embodiments use a solution composed of salt and water. Various spices can also be added to the food product to enhance flavor and thereby reduce the reliance on salt for flavoring. The various spices can be, but not limited to, one or more of onion powder, garlic powder, chili powder, ginger, turmeric, paprika, lemon juice extract, sugar, and/or black pepper.

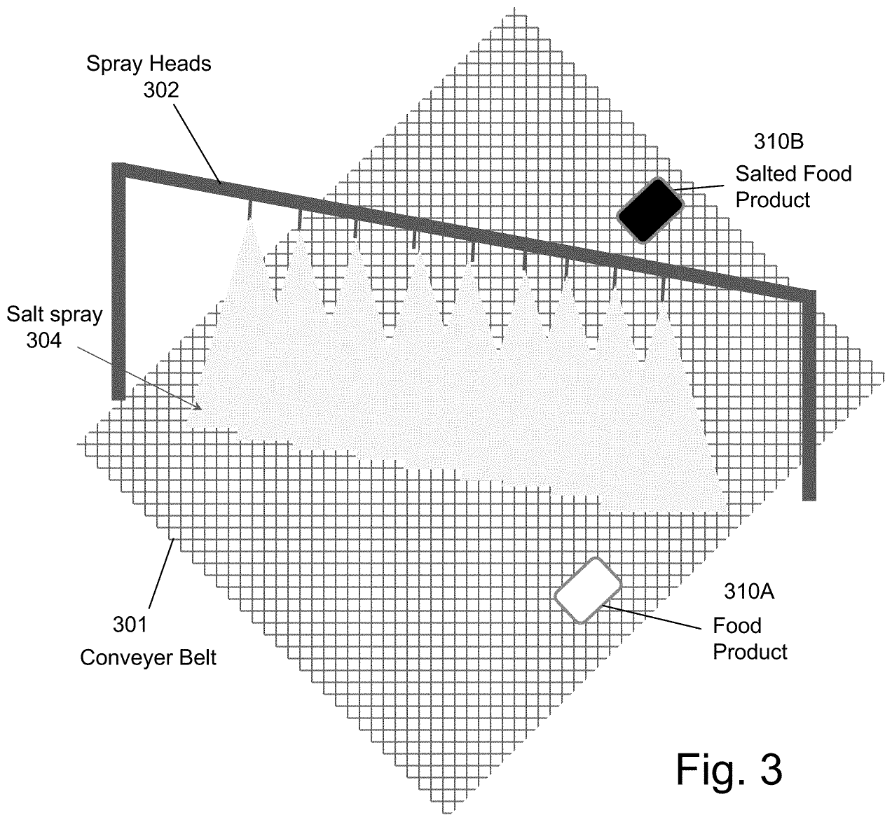

Referring now to FIG. 3, an exemplary method of processing the food product with the salt solution is shown. A solution of water and salt is premixed to a known and selectable concentration. The concentration of salt that is premixed with water in the salt solution can depend on the food product that is to be prepared using this method. For example, a saturated salt solution at high temperature can be premixed if the desired level of saltiness of the food product is high. A saturated solution can also be preferred if the salt solution is lightly sprayed on the food products because a soggy food product is undesirable, e.g., potato chips, cracker, etc.

In FIG. 3, the salt solution can be readily sprayed as a salt spray 304 across the outside surfaces (top outer surface and bottom outer surface, leaking over onto the side outer surfaces) of the food product 310A to form the salt coated food product 310B. In accordance with one embodiment, the food product can be moved by a conveyor belt 301 under top spray heads 302 that spray out the salt solution 304 onto a top outer surface of the food product 310A (e.g., a burger patty). The food product 310A can be flipped on the conveyer belt 301 and then moved under a second set of top spray heads (not shown in FIG. 3) that can spray out the salt solution 304 to apply it to the (originally) bottom outer surface area of the food product 310A. In an alternate embodiment, the food product 310A can then be flipped on the conveyer belt 301 and then moved back (reverse direction) under the first set of top spray heads 302. In yet another alternate embodiment, a more complex arrangement of sprayer heads can be used to coat the outer surface(s) of the food product. The top spray heads 302 and bottom spray heads (not shown in FIG. 3, and/or side spray heads not shown in FIG. 3) can be used with a screen mesh conveyer belt 301 for a more even coating on all exposed outer surfaces of the food product 310A. In this manner, the food product can be moved by a conveyor belt under top spray heads and over bottom spray heads (not shown) that spray out the salt solution without flipping the food product 310A to form the salt coated food product 310B.

In any case, the outside surface of the food product can have an even coat of salt on a top outside surface and a bottom outside surface. By having an even coat on outside surfaces, the food product is properly salted to taste. After which, the salt coated food product 310B can be packaged in a wrapper and boxed and/or further assembled with other food items (e.g., bread buns, pickles, lettuce, tomatoes, ketchup, mayonnaise and/or cheese). After packaging and/or further assembly, the food product can be hand delivered to a customer or preserved (e.g., refrigerated and/or frozen) and shipped to a retail distributor, such as a grocery store.

The conveyor method of forming the salted vegetable burger patty previously disclosed, can be applied to various other food products (e.g., thinly sliced vegetables, such as potatoes; pretzels; crackers; corn chips; and nuts). For example, unsalted potato chips and unsalted crackers can be similarly coated with salt using the same method to form salt coated potato chips and salt coated crackers and is within the abilities and understanding of a person of ordinary skill in the art.

Another exemplary method to reduce or substitute salt inside a food product is by adding various spices to it during formation. Adding different flavors, especially spicy ones, reduces a person's craving for salt. Non-salt spices can be added to the inside of a burger in addition to the presence of small amounts of salt coated on the outside surface of the burger. For example, by adding chili powder, turmeric, and/or black pepper into a veggie burger, it can make the salt coated veggie burger tastier for people. The spices inside the burger act as a salt substitute, providing flavor and spice to combat the human craving for salt. One or more of onion powder, garlic powder, chili powder, turmeric, paprika, ginger, lemon juice extract, sugar, and/or black pepper are the spices that can be used to add in a strong flavor to a food product. Turmeric is known to have many positive health effects. Chili powder can add in a spicy flavor to distract from the reduced salt content and lack of salt inside the patty.

In one embodiment, both the outer salt solution coating and non-salt spices are internally added to a burger patty to reduce the amount of salt within it. The non-salt spices are internally added to the burger patty, prior to it undergoing the salt coating process, such as shown in FIG. 3. In a typical vegetarian burger, there can be roughly triple the amount of salt than there would be in a typical meat burger. Producing the vegetarian burger in accordance with disclosed embodiments, the amount of salt needed for a delicious vegetarian burger is significantly reduced.

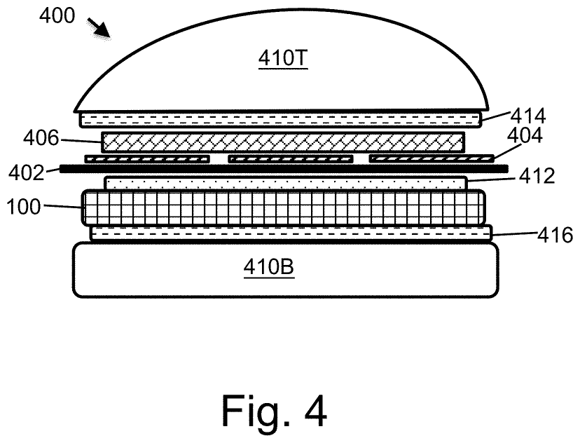

FIG. 4 illustrates a vegetable hamburger 400 including the salt coated vegetable patty 100 between a top bun 410T and a bottom bun 410B (the top bun 410T and the bottom bun 410B can be collectively referred to as a bun). The top bun 410T and the bottom bun 410B are formed out of bread. U.S. Pat. No. 4,220,065 titled HAMBURGER BUNS AND METHOD OF PREPARING SAME issued to Arthur Stanford on Sep. 2, 1980, incorporated herein by reference for all intents and purposes, describes methods of preparing hamburger buns.

The salt coated vegetable patty 100 is formed out of vegetables, and has salt particles applied to outside surfaces thereof. U.S. Pat. Nos. 2,162,729, 2,682,466, 2,830,902, 3,102,031, 3,142,571, 3,343,963, 3,485,636, 3,620,755, 3,814,823, 3,940,495, 4,001,441, 4,057,656, 5,160,758, 5,571,545, 5,663,058, and 7,070,827, incorporated herein by reference for all intents and purposes, describe meat substitutes (plant proteins and vegetable proteins) that can be used for ground beef in a hamburger patty and other protein food products. One or more spices, other than salt, can be inserted into the vegetable patty 100 as it is formed. The one or more spices can be, but not limited to, onion powder, garlic powder, chili powder, turmeric, paprika, ginger, lemon juice extract, sugar, and/or black pepper.

As discussed herein, the salt particles are applied to the outside surfaces of the vegetable patty by spraying a salt and water solution onto the vegetable patty and evaporating the water. The salt particles have a smaller diameter than standard granulated table salt.

The vegetable hamburger 400 can further have, between the top bun 410T and the bottom bun 410B, one or more pickles 404, one or more tomatoes 406, and/or lettuce 402. The vegetable hamburger 400 can further include ketchup 416 applied to the patty 100, an inner surface of the top bun 410T, and/or an inner surface of the bottom bun 410B. The vegetable hamburger 400 can further include mayonnaise 414 applied to an inner surface of the top bun 410T and/or the bottom bun 410B. The vegetable hamburger 400 can further include a cheese slice 412 between the top bun 410T and/or the bottom bun 410B. The cheese slice 412 can be applied to the top or bottom surface of the patty 100.

One advantage of the embodiments is that food products can be made healthier. Salt is removed from inside prior art burger patties and used instead as a coating on the outside surface of the burger patty. Taste buds in the tongue tastes salt sooner, enjoying the flavor, even though there is less salt overall in the burger patty. A side benefit of this invention could be the widespread adoption of meatless food products, which can reduce the carbon footprint of the meat industry. If a vegetarian alternative that did not sacrifice on taste could be made with less salt, adoption of meatless alternatives will likely increase.

While certain exemplary embodiments have been described and shown in the accompanying drawings, it is to be understood that such embodiments are merely illustrative of and not restrictive on the broad invention, and that the embodiments of the invention not be limited to the specific constructions and arrangements shown and described, since various other modifications may occur to those ordinarily skilled in the art.

While this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed invention is limited only by patented claims that follow below.

1. A method comprising:
moving a food product over a conveyer belt;
spraying a salt solution onto outside surfaces of the food product;
drying the salt solution on the outside surfaces of the food product forming salt particles thereon as a salt coated food product; and
packaging the salt coated food product into a package as a packaged salt coated food product.

2. The method of claim 1, wherein
the salt coated food product is a hamburger patty.

3. The method of claim 2, wherein
the hamburger patty is a vegetable hamburger patty.

4. The method of claim 1, wherein
the salted coated food product is a meatless food product.

5. The method of claim 1, further comprising:
preserving the packaged salt coated food product.

6. The method of claim 5, further comprising:
shipping the packaged salt coated food product to retail distributors including grocery stores.

7. The method of claim 1, wherein
the food product includes one or more of turmeric, chili powder, and/or black pepper inserted into one or more inner layers of the food product.

8. A vegetable hamburger comprising:
a top bun formed out of bread;
a bottom bun formed out of bread; and
a vegetable patty between the top bun and the bottom bun, the vegetable patty is formed out of vegetables, has salt particles applied to outside surfaces thereof, and spices, other than salt, inserted into the vegetable patty,
wherein the salt particles are applied to the outside surfaces of the vegetable patty by spraying a salt and water solution onto the vegetable patty and evaporating the water, the salt particles having a smaller diameter than standard granulated table salt.

9. The vegetable hamburger of claim 8, wherein
the salt particles have a diameter of less than one millimeter.

10. The vegetable hamburger of claim 8, wherein
the vegetable patty includes one or more spices of onion powder, garlic powder, chili powder, ginger, turmeric, paprika, lemon juice extract, sugar, and/or black pepper.

11. The vegetable hamburger of claim 8, further comprising:
one or more pickles between the top bun and the bottom bun,
ketchup applied to a surface of the patty, and
mayonnaise applied to an inner surface of the top bun and/or the bottom bun.

12. The vegetable hamburger of claim 11, further comprising:
one or more tomatoes and lettuce between the top bun and the bottom bun.

13. The vegetable hamburger of claim 11, further comprising:
a cheese slice between the top bun and the bottom bun.

14. A food product comprising:
thinly sliced vegetables; and
a thin coating of salt deposits coating the thinly sliced vegetables, wherein the salt deposit formed by
spraying a water and salt solution on the outer surfaces of the thinly sliced vegetables, and
evaporating the water leaving behind a thin coating of salt deposits on the outer surfaces of the thinly sliced vegetables composed of salt crystals having an average crystal size smaller than granulated table salt.

15. The food product of claim 14, wherein
the thinly sliced vegetables are baked.

16. The food product of claim 14, wherein
the thinly sliced vegetables are fried in an oil.

17. The food product of claim 14, further comprising:
one or more spices inserted into the thinly sliced selected from the group comprising onion powder, garlic powder, chili powder, ginger, turmeric, lemon juice extract, sugar, and/or pepper.

18-20. (canceled)

21. The food product of claim 14, wherein
the thinly sliced vegetables are potatoes.

22. The food product of claim 15, wherein
the thinly sliced vegetables are potatoes.

23. The food product of claim 16, wherein
the thinly sliced vegetables are potatoes.
